(19) United States
(12) Patent Application Publication
(10) Pub. No.: US 2002/0041584 A1
(43) Pub. Date: Apr. 11, 2002

(54) Asynchronous interference avoidance technique in TDMA communications system

(75) Inventor: Toshiyuki Sashihara, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/970,577

(22) Filed: Oct. 4, 2001

(30) Foreign Application Priority Data
Oct. 5, 2000 (JP) 2000-305931

(51) Int. Cl. H04B 7/212

(52) U.S. Cl. 370/337; 370/386

(57) ABSTRACT

A method allowing effective avoid asynchronous interference that occurs in the area where different cells overlap is disclosed. In a TDMA system, a base station desirous of using a channel transmits an interference check signal at a slot corresponding to each of transmission and reception timings on the channel to check whether asynchronous interference occurs on the channel. A mobile station determines whether asynchronous interference occurs on the channel, based on a plurality of error packet reception results on the channel. When asynchronous interference occurs, the mobile station transmits an interference notification signal to the base station. The base station, when receiving an error packet or the interference notification signal, determines that asynchronous interference occurs, and selects another channel to avoid asynchronous interference.

### BACKGROUND OF THE INVENTION

1. Field of the Invention

The present invention relates to a mobile communications system using the time-division multiple-access (TDMA) scheme and, more specifically, to an asynchronous interference avoidance technique for use in the mobile communications system.

2. Description of the Related Art

With the widespread use of mobile communications systems such as cellular telephones, the amount of traffic is increasing more and more in limited frequency bandwidths. To respond the growing need for increasing the number of lines within the limited frequency bandwidths, the TDMA scheme has been adopted in many mobile communications systems because TDMA allows a single frequency to be shared among a plurality of systems to achieve efficient use of frequency resources.

In other words, each radio station in the TDMA system controls transmitting and receiving timings to avoid transmission conflict. Timing synchronization can be obtained in the same system, But it is practically impossible to synchronize different systems without taking any countermeasures because the system clock frequencies of the different systems will go out of synchronization with each other as time goes by. When the system clock frequencies are out of synchronization, interference between different systems occurs, which is called asynchronous interference. It is necessary to avoid such an asynchronous interference.

There have been proposed several asynchronous interference avoidance methods. In Japanese Patent Application Unexamined Publication No. 7-67169, for example, a TDMA mobile communications system having an asynchronous interference detector at either a cell station or a mobile station has been disclosed.

In the conventional TDMA mobile communications system, it is assumed that the cell station is equipped with the asynchronous interference detector and a mobile station is communicating with the cell station using a certain slot at a frequency. In this state, the cell station uses another slot that is not usually used for communication to search for another available slot at a frequency channel as a reserved slot. When such a reserved slot is found at a certain frequency, the cell station notifies the mobile station of information of the reserved slot.

In addition, the asynchronous interference detector measures received signal levels at a plurality of points of the in-use slot. The measured signal levels are used to determine whether asynchronous interference occurs. If the asynchronous interference occurs, the cell station switches to the reserved slot to continue the communication without interruption.

However, the above prior art has the following disadvantages.

In the case where a cell station detects the reserved slot, the reserved slot is an available slot that is detected at the location of the cell station. Accordingly, when the mobile station is located at an overlapping area of a cell of the cell station and an adjacent cell of the adjacent cell station, a slot detected as an available slot by one cell station is not always an available slot for the other cell station, In this case, it is necessary to manage frequencies and slots used by the adjacent cell stations. However, it is not practical to determine the availability of each frequency and slot, especially in the case of a relatively low transmission power system such as PHS (Personal Handy-phone System). The reason is that the cell shape is significantly affected by buildings and the like an therefore it is difficult to determine simply from the locations of cell stations whether cell overlapping occurs.

In the case where a mobile station provided with the asynchronous interference detector has the function of searching for a reserved slot, the mobile station notifies the cell station of the reserved slot information. When a signal from the mobile station stops dead, the cell station knows that the asynchronous interference has occurred. Accordingly, it is necessary for each cell station to know all mobile stations located in the cell thereof and monitor the presence or absence of a signal received from each or the mobile stations located therein. When a large number of mobile stations are accommodated, the cell station becomes put under heavy load. Further, when receiving different reserved slot information from each mobile station, the cell station cannot determine which should be used in case of occurrence of asynchronous interference.

### SUMMARY OF THE INVENTION

An object of the present invention is to provide an asynchronous interference avoidance method that can effectively avoid asynchronous interference that occurs in the area where different cells overlap.

According to the present invention, in a TDMA (time division multiple access) system allowing communications among a plurality of base stations and mobile stations, a base station desirous of using a channel to transmit and receive signals transmits a first predetermined signal at a slot corresponding to each of transmission and reception timings on the channel to check whether asynchronous interference occurs on the channel. A mobile station located in an area where the first predetermined signal can propagate determines whether asynchronous interference occurs on the channel, based on a plurality of error packet reception results on the channel, and when it is determined that asynchronous interference occurs, notifies the base station of occurrence of the asynchronous interference. The base station, when the base station is successfully notified of occurrence of the asynchronous interference, determines that asynchronous interference occurs, when receiving at least one error packet on the channel, determines that asynchronous interference occurs, and when it is determined that asynchronous interference occurs on the channel, selects another channel to avoid asynchronous interference.

According to one aspect of the present invention, a method for avoiding asynchronous interference in a TDMA (time division multiple access) system allowing communications among a plurality of base stations and mobile stations, includes the steps of: at a base station desirous of using a channel, a) transmitted an interference check signal at a slot corresponding to each of transmission and reception timings on the channel to check whether asynchronous interference occurs on the channel; at a mobile station located in an area where the interference check signal can propagate, b) determining whether asynchronous interference occurs on the channel, based on a plurality of reception results on the channel; c) when it is determined that asynchronous interference occurs, transmitting an interference notification signal back to the base station; and at the base station, d) when receiving one of the interference notification signal and an error packet as a response to the interference check signal at a receiving slot on the channel, determining that the channel is not available, and selecting another channel to avoid asynchronous interference.

Preferably, in the step a), the interference check signal is transmitted a predetermined number of times. In the step b), it is determined that asynchronous interference occurs on the channel when at least a predetermined number of error packets are included in the plurality or reception results. In the step d), it is determined that the channel is not available when at least a predetermined number of error packets have been received on the channel. Accordingly, when a mobile station communicating with one base station at a channel has received an interference check signal from another base station desirous of the channel, the mobile station detects interference and transmits an interference notification signal back to the other base station desirous of the channel.

Preferably, in the step a), the interference check signal is transmitted a plurality of times according to a predetermined check signal transmission pattern. In the step b), it is determined that asynchronous interference occurs on the channel when an error packet reception pattern included in the plurality of reception results matches the predetermined check signal transmission pattern. In the step d), it is determined that the channel is not available when at least a predetermined number of error packets have been received on the channel. Since the transmission pattern of the interference check signal is previously determined, the interference detection can be made more reliably with reducing in the number of times the interference check signal transmits.

In the step c), the interference notification signal may be transmitted a plurality of times according to a predetermined notification signal transmission pattern. In the step d), it may be determined that the channel is not available when an error packet reception pattern matches the predetermined notification signal transmission pattern.

According to still another aspect of the present invention, in a mobile communications system using TDMA scheme allowing communications among a plurality of base stations and mobile stations, each of the base stations includes: a base communication controller controlling such that, when desiring to use a channel, an interference check signal is transmitted at a slot corresponding to each of transmission and reception timings on the channel, and a channel controller controlling such that a channel to be used is changed to another channel to avoid asynchronous interference when receiving one of the interference notification signal and an error packet as a response to the interference check signal at a receiving slot on the channel. Each of the mobile stations includes: a reception result memory for storing a predetermined number of last packet reception results; an interference detector for detecting asynchronous interference on the channel based on the predetermined number of last packet reception results when receiving one of the interference notification signal and an error packet as a response to the interference check signal at a receiving slot on the channel; and a mobile communication controller controlling such that, when asynchronous interference is detected, an interference notification signal is transmitted back to the base station.

### BRIEF DESCRIPTION OF THE DRAWINGS

FIG. 1 is a diagram showing a mobile communications system adopting an asynchronous interference avoidance method according to a first embodiment of the present invention;

FIG. 2 is a time chart showing a synchronization operation between a temporary base station and a mobile station according to the first embodiment;

FIG. 3 is a diagram showing a format or a collision control downlink packet that is sent from a temporary base station;

FIG. 4 is a block diagram showing a circuit structure of an asynchronous interference avoidance section in a temporary base station or a mobile station according to the first embodiment of the present invention;

FIG. 5 is a schematic diagram showing the mobile communications system for explanation of the operation of the first embodiment;

FIG. 6 is a flow chart showing the control operation of a mobile station according to the first embodiment;

FIG. 7 is a flow chart showing the control operation of a temporary base station according to the first embodiment,

FIG. 8 is a time chart showing a normal synchronization operation between one temporary base station and a mobile station in the case where the other temporary base station does not operate;

FIG. 9 is a time chart showing a synchronization operation between one temporary base station and a mobile station in the case where the other temporary base station transmits an interference check signal;

FIG. 10 is a block diagram showing a circuit structure of an asynchronous interference avoidance section in a temporary base station or a mobile station according to a second embodiment of the present invention;

FIG. 11 is a diagram showing a plurality of interference check signal transmission patterns according to the second embodiment;

FIG. 12 is a time chart showing a synchronization operation between one temporary base station and a mobile station in the case where the other temporary base station transmits an interference check signal according to a third embodiment of the present invention; and

FIG. 13 is a block diagram showing a circuit structure of an asynchronous interference avoidance section in a temporary base station or a mobile station according to a fourth embodiment or the present invention.

### DESCRIPTION OF THE PREFERRED EMBODIMENTS

1. First Embodiment

1.1) Network configuration

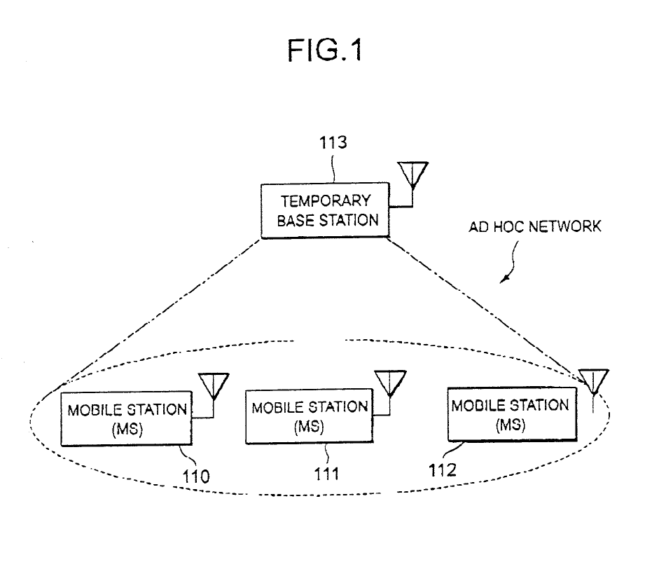

Referring to FIG. 1, it is assumed for simplicity that a mobile communications system according to a first embodiment of the present invention is composed of a plurality of mobile stations (MSs) 110-112 and a temporary base station 113. The mobile stations 110-112 and the temporary base station 113 are terminals of the mobile communications system, which have the same internal circuit structure. In other words, each of the terminals can act as either of a temporary base station and a mobile station. An ad hoc network is instantaneously formed using a plurality of terminals, wherein one terminal acts as a temporary base station and the other terminals act as mobile stations.

In this embodiment, the inter-terminal direct communication carrier of personal handy-phone system (PHS) is used to make communications between the temporary base station 113 and the mobile stations 110-112. The PHS access scheme is the four-channel multiplexed time division multiple access-time division duplex (TDMA-TDD). Such a mobile communications system uses one channel per ad hoc network.

In the ad hoc network, the temporary base station 113 operates at its own slot timing without synchronized with other stations, but the mobile stations 110-112 are synchronized with the temporary base station 113 such that the receiving slot of each mobile station is synchronized with the transmitting slot of the temporary base station 113 and the transmitting slot of each mobile station is synchronized with the receiving slot of the temporary base station 113. Since one receiving slot of the temporary base station 113 is shared among plural mobile stations 110-112, collision control is needed to prevent the mobile stations 110-112 from concurrently transmitting packets.

1.2) Collision control

Here, ICMA-PE (Idle-signal Casting Multiple Access with Partial Echo) technique is adopted as the collision control scheme. According to ICMA-PE, the temporary base station 113 transmits a downlink packet for collision control at the transmitting slot thereof to the mobile stations 110-112. Taking a synchronization operation between the temporary base station 113 and the mobile station 110 as an example, the details will be described hereinafter.

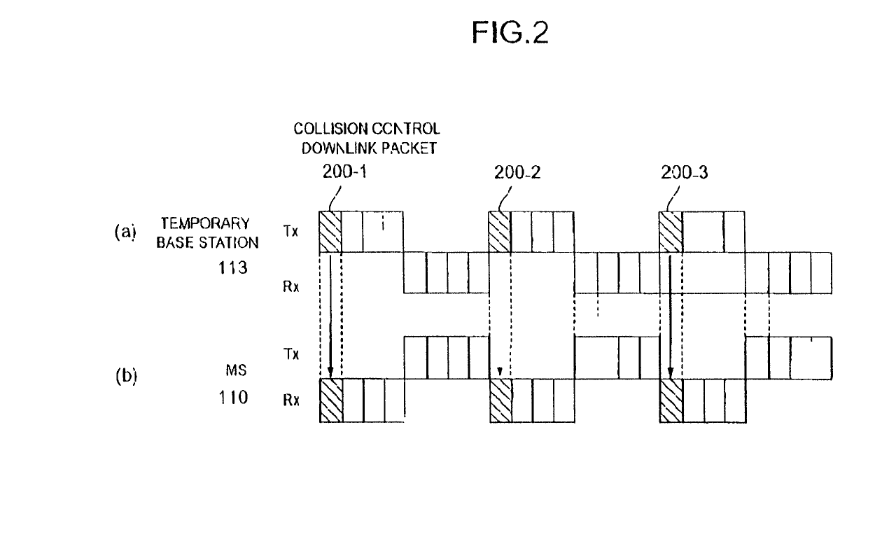

Referring to FIG. 2, the temporary base station 113 periodically transmits collision control downlink packets 200_1, 200_2, 200_3, . . . . By receiving these collision control downlink packets at regular intervals, the mobile station 110 is synchronized with the temporary base station 113.

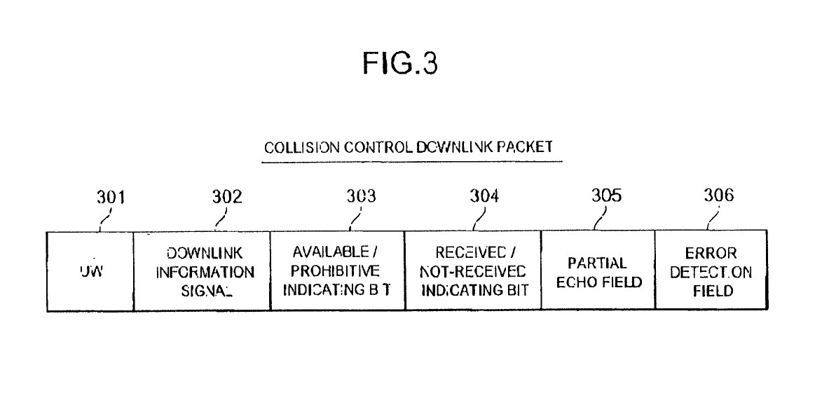

As shown in FIG. 3, the collision control downlink packet is composed of unique word (UW) 301, downlink information signal 302, available/prohibitive indicating bit 303, received/not-received indicating bit 304, partial echo field 305, and error detection field 306.

The unique word (UW) 301 is a predetermined bit pattern which is used for synchronization. The downlink information signal 302 is data that is transmitted from the temporary base station to a mobile station. The available/prohibitive indicating bit 303 is used to indicate whether access from other mobile stations is permitted. When the bit 303 indicates “prohibitive”, the access from other mobile stations is prohibited.

The received/not-received indicating bit 304 indicates whether data has been successfully received. When data having no errors has been normally received, the bit 304 indicates “received”. When erroneous data that cannot be recovered has been received or no data is received, the bit 304 indicates “not-received”. When “not-received” is indicated on signal transmission, the mobile station that is now transmitting the signal temporarily stops data transmission and enters retransmission procedure.

The partial echo field 305 is used to indicate a part of data received by the temporary base station. The mobile station checks the partial data against the data transmitted by the mobile station itself to determine whether the data transmitted by the mobile station itself was normally received by the temporary base station. The error detection field 306 is used to check whether a received packet has no error.

When the temporary base station constructs an ad hoc network, previously assigned channels are searched for an available channel according to a predetermined procedure. If an available channel is found, the available channel is used to transmit the above-described collision control packet consecutively.

1.3) Circuit structure

As mentioned above, the mobile stations 110-112 and the temporary base station 113 are terminals of the mobile communications system, which have the same internal circuit structure allowing either of a temporary base station and a mobile station.

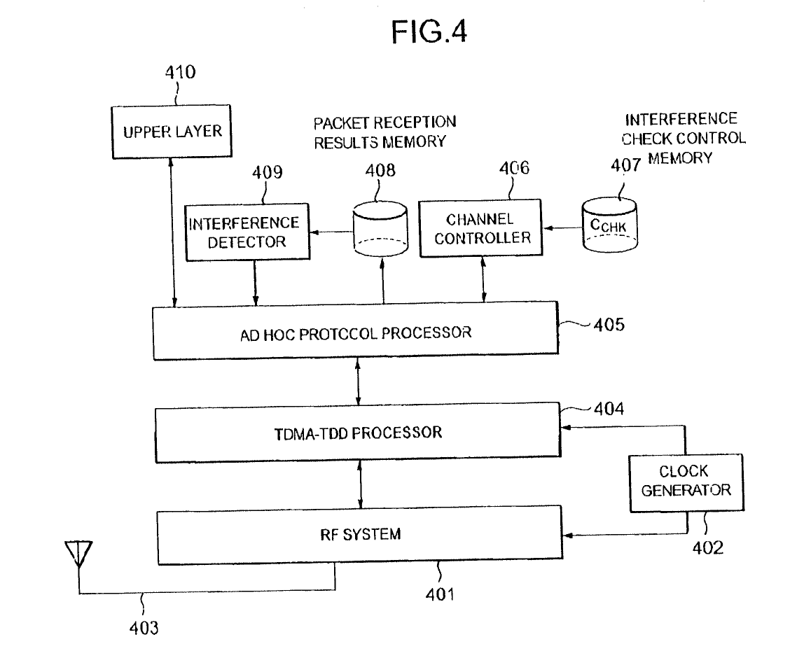

Referring to FIG. 4, a terminal is provided with a radio-frequency (RF) system 401 that performs transmission and reception of radio signals through an antenna section 403 and modulation and demodulation thereof. A clock generator 402 generates a clock signal and supplies it to the RF system 401 and a TDMA-TDD processor 404.

The TDMA-TDD processor 404 performs TDMA-TDD processing and further performs other predetermined operations under instructions of an ad hoc protocol processor 405. More specifically, the TDMA-TDD processor 404 receives data on a channel designated by the ad hoc protocol processor 405 and transfers it to the ad hoc protocol processor 405, transmits data designated by the ad hoc protocol processor 405 through the RF system 401 at a channel designated by the ad hoc protocol processor 405, monitors the received electric field strength on the designated channel. Further if the unique word cannot be detected when receiving the data at the designated channel, the TDMA-TTD processor 404 notifies the ad hoc protocol processor 405 that the unique word cannot be detected. Furthermore, if a CRC error is detected when receiving the data as the designated channel, the TDMA-TDD processor 404 notifies the ad hoc protocol processor 405 that the CRC error has been detected.

The ad hoc protocol processor 405 constructs and maintains the ad hoc network by transmitting and receiving control signals through the TDMA-TDD processor 404 and transmitting and receiving data of an upper layer 410 through the TDMA-TDD processor 404.

A channel controller 406 has a function of determining a channel to be used by searching for an available channel. This channel determining function is activated when the ad hoc network is constructed and interference occurs.

An interference check control memory 407 stores the number of Times (C_{DHK}) an interference check signal has been transmitted to check whether asynchronous interference occurs on a channel to be used.

A packet reception results memory 408 stores reception results. In the last predetermined number of slots: normal; CRC error; no unique word; or uninterpretable.

An interference detector 409 determines whether asynchronous interference occurs, depending on whether an error packet that is anything other than a normally received packet were received the predetermined number of times or more in the last predetermined number of slots,

The upper layer 410 is an application performing data transmission and reception using the ad hoc protocol.

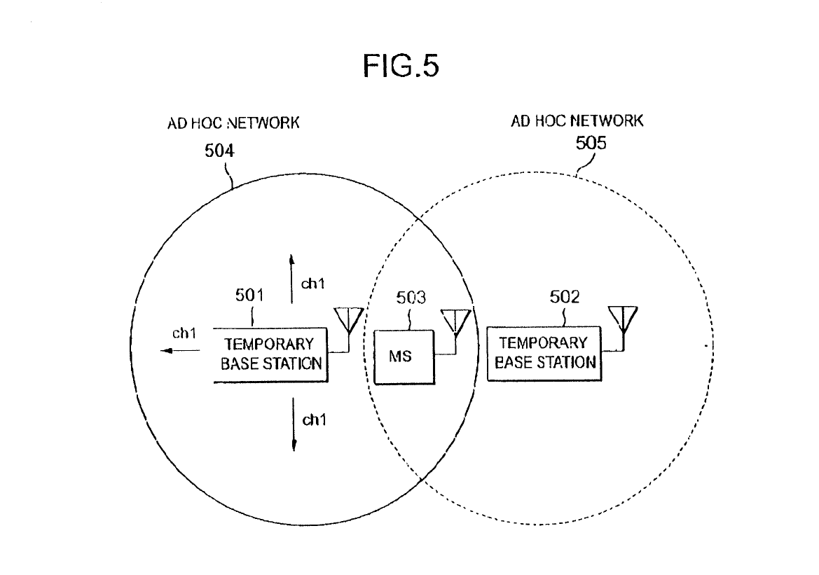

An asynchronous interference avoidance operation of the above-described terminal will be described in detail with reference to FIGS. 5-9.

1.4) Asynchronous interference avoidance

In the case of no conflict, operations of the mobile station and temporary base station will be described by referring to FIGS. 5-8.

Referring to FIG. 5, it is assumed that a temporary base station 501 holds an ad hoc network 504 using a channel ch1 and a mobile station 503 is located in the ad hoc network 504. In this situation, another temporary base station 502 does not hold another ad hoc network 505, in which the mobile station 503 will be located if the ad hoc network 505 is held. Accordingly, the temporary base station 501 periodically transmits a collision control downlink packet using a transmitting slot of the channel ch1. Since the temporary base station 502 transmits nothing, the mobile station 503 receives the collision control downlink packet from the temporary base station 501 at regular intervals.

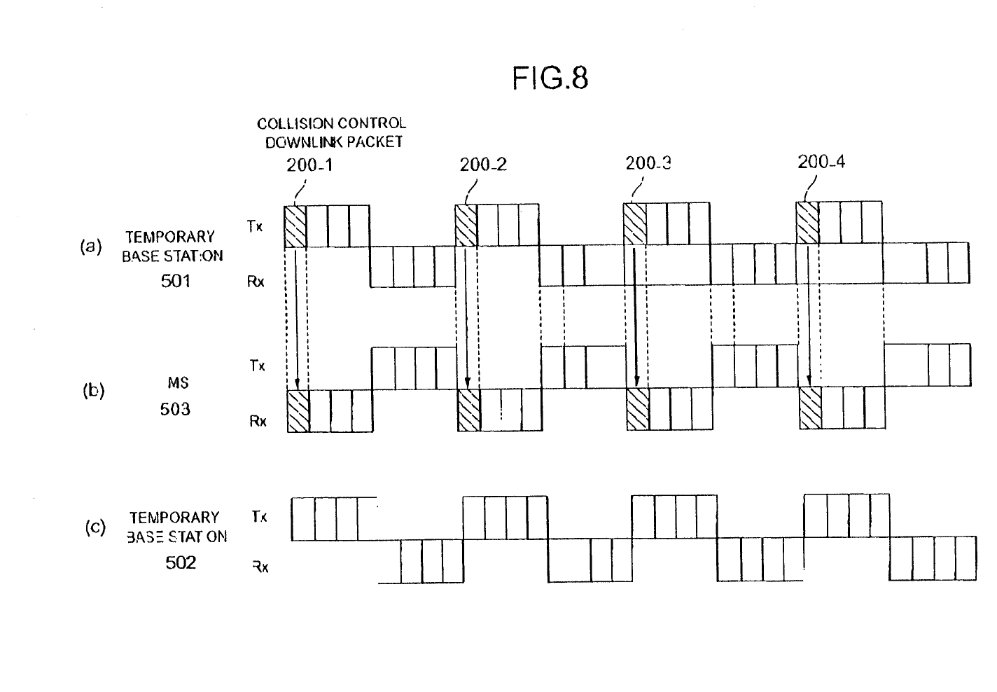

As shown i FIG. 8, the temporary base station 501 periodically transmits collision control downlink packets 200_1, 200_2, 200_3, . . . . By receiving these collision control downlink packets at regular intervals, the mobile station 503 is synchronized with the temporary base station 501. In this case of no collision, no error packet occurs between the temporary base station 501 and the mobile station 503, the unique word is successfully detected, no CRC error is detected, and the received signal is interpretable in the ad hoc protocol processor 405.

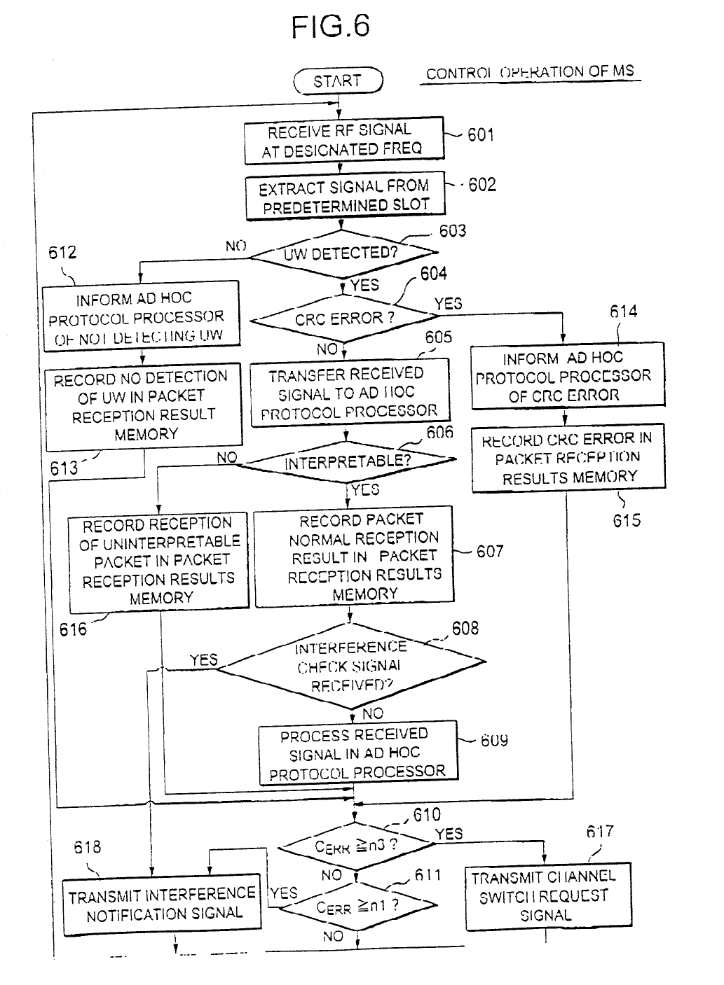

A control operation of the mobile station 503 in this case will be described by referring to FIG. 6. Here, N. n1, n2, and n3 are defined as follows:

N is the last predetermined number of slots during which packet reception results memory 400 stores reception results.

n1 is the predetermined number of error packets in the last N received packets, which is a threshold that the interference detector 408 uses to determine whether asynchronous interference occurs.

n2 is the maximum number of consecutive times an interference check packet is to be transmitted according to an instruction from the channel controller 406.

n3 is a threshold such that, when the number of error packets (C_{ERR}) in the last N packets is equal to or greater than n3, the channel is switched to another one because it does not satisfy required communication quality. In this case, the mobile station 503 transmits a channel switch request signal to the temporary base station with which the mobile station 503 is now communicating.

N, n1, n2, and n3 are positive integers and satisfy N >n3>n2>n1. For example, N=240, n3=120, n2=110, and n1=100.

Referring to FIG. 6, the RF system 401 of the mobile station 503 receives a signal on a carrier to which the channel ch1 belongs from the temporary base station 501 and transfers it to the TDMA-TDD processor 404 (step 601). The TDMA-TDD processor 404 extracts a signal from a predetermined slot of the received signal on the channel ch1 (step 602) and determines whether a unique word is detected from the extracted signal (step 603). Since the unique word is found in this case (YES in step 603), the TDMA-TDD processor 404 subsequently determines whether some CRC error is detected (step 604). Since no CRC error is detected in this case (NO in step 604), the TDMA-TDD processor 404 transfers the received signal to the ad hoc protocol processor 405 (step 605).

The ad hoc protocol processor 405 determines whether the received signal is interpretable (step 606). Since it is interpretable in this case (YES in step 606), the ad hoc protocol processor 405 records a packet reception result indicative of normal reception in the packet reception results memory 408 (step 607). Thereafter, the ad hoc protocol processor 405 determines whether the received signal is an interference check signal (step 608). Since it is the collision control downlink packet in this case (NO in step 600), the ad hoc protocol processor 405 processes the received signal (step 609).

Subsequently, the interference detector 400 checks the packet reception results memory 408 to count the number of error packets (C_{ERR}) included in the last N reception results, where an error packet is a packet with CRC error or not-detecting the unique word. The interference detector 409 determines whether C_{ERR} is equal to or greater than n3 (step 610). Since C_{ERR}<n3 in this case because no error packet is received (NO in step 610), It is further determined whether C_{ERR} is equal to or greater than n1 (steel 611). Since C_{ERR}<n1 in this case because no error packet is received (NO in step 611), the control goes back to the step 601 to receive a next signal.

In the case of occurrence of conflict, operations of the mobile station and temporary base station will be described by referring to FIGS. 5-7 and 9.

As shown in FIG. 5, it is assumed that, in the situation that the temporary base station 501 holds the ad hoc network 504 using the channel ch1, a received electric field strength on the channel ch1 at the location of another temporary base station 502 is lower than a predetermined threshold E which is used to determine whether the channel is occupied by another station. The temporary base station 502 desirous of holding the ad hoc network 505 on the channel ch1 first checks to see that the channel ch1 is available.

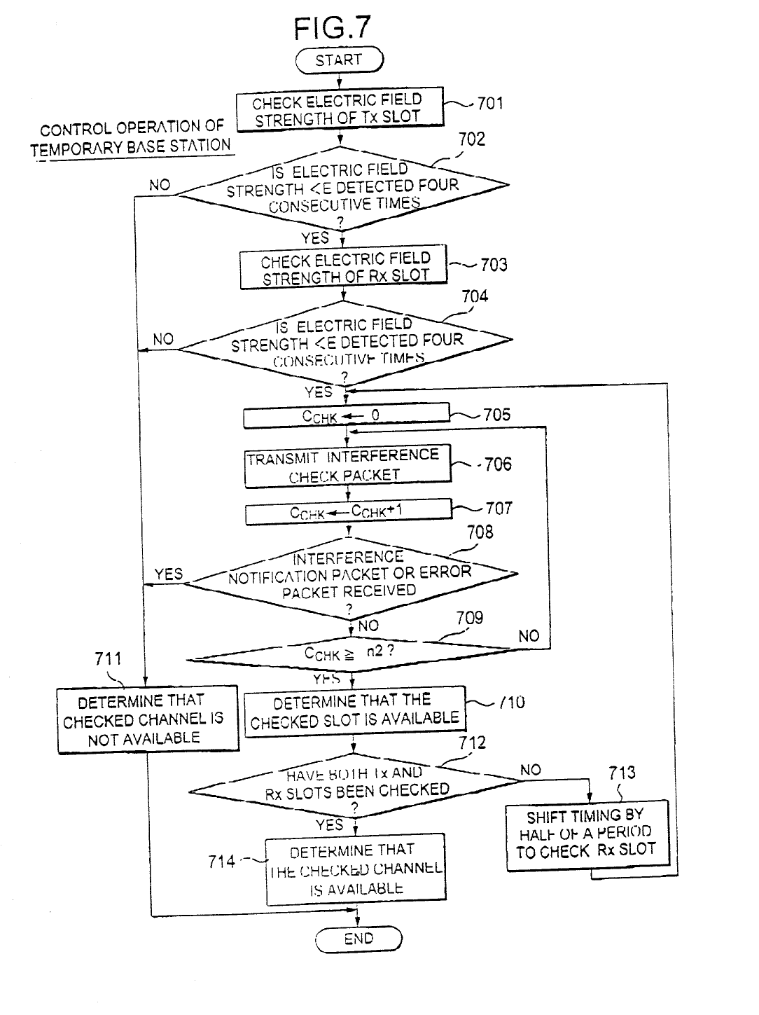

Referring to FIG. 7, more specifically, the ad hoc protocol processor 405 of the temporary base station 502 instructs the TDAM-TDD processor 404 to check whether the electric field strength at the transmitting slot of the channel ch1 is lower than the threshold E four consecutive times (step 701). In this case, the electric field strength at the transmitting slot <E four consecutive times, that is, the transmitting slot of the channel ch1 is available (YES in step 702). Similarly, it is checked whether the electric field strength at the receiving slot of the channel ch1 is lower than the threshold C four consecutive times (step 703). Since the electric field strength at the receiving slot <E four consecutive times in this case (YES in step 704), the interference check packet transmission count C_{CHK} stored in the interference check control memory 407 is reset to 0 (step 705).

Thereafter, the ad hoc protocol processor 405 of the temporary base station 502 instructs the TDAM-TDD processor 404 to transmit an interference check packet (step 706) and increment the interference check packet transmission count C_{CHK} by 1 (step 707). Then, it is determined whether an interference notification packet or error packet is received at the receiving slot immediately following transmission of the interference check packet (step 708).

When neither interference notification packet nor error packet is received (NO in step 700), it is determined whether the interference check packet transmission count C_{CHK} is equal to or greater than n2 (step 700). If C_{CHK} <n2 (NO in step 709), then the control goes back to the step 706 to transmit an interference check packet again. If C_{CHK}>−n2 (YES in step 709), then it is determined that no asynchronous interference occurs at the slot in question, that is, the slot is available (step 710). Here, it is determined that the transmitting slot of the channel ch1 is available.

Thereafter, it is determined whether both transmitting and receiving slots of the channel ch1 have been checked (step 712). In this stage, the receiving slot has not been checked (NO in step 712). Accordingly, the transmission and reception timings are shifted by half of the period (step 713) and the control goes back to the step 705 to similarly check to see that the receiving slot is available. When the receiving slot is also available (YES in step 712), it is determined that the channel ch1 is available (step 714).

The operation of the mobile station 503, when receiving the interference check signal from the temporary base station 502, will be described hereafter. As described before, there is no means for synchronizing the temporary base stations 501 and 502. Accordingly, when the mobile station 503 receives the interference check signal from the temporary base station 502, it is considered that the following three cases occur.

Case 1) Reception or the interference check signal from the temporary base station 502 is accidentally coincident with the receiving timing of the mobile station 503 while the temporary base station 501 transmits nothing. In this case, the mobile station 503 accepts the interference check signal. However, since the temporary base station 501 periodically transmits the collision control downlink packet, this case is pure coincidence.

Case 2) Reception of the interference check signal from the temporary base station 502 is not coincident with the receiving timing of the mobile station 503 while the temporary base station 501 transmits some signal, the unique word section of which does not come into collision with the interference check signal from the temporary base station 502. In this case 2), the mobile station 503 detects the CRC error.

Case 3) Reception of the interference check signal from the temporary base station 502 is not coincident with the receiving timing of the mobile station 503 while the temporary base station 501 transmits nothing or some signal, the unique word section of which comes into collision with the interference check signal from the temporary base station 502. In this case 2), the mobile station 503 does not detect the unique word.

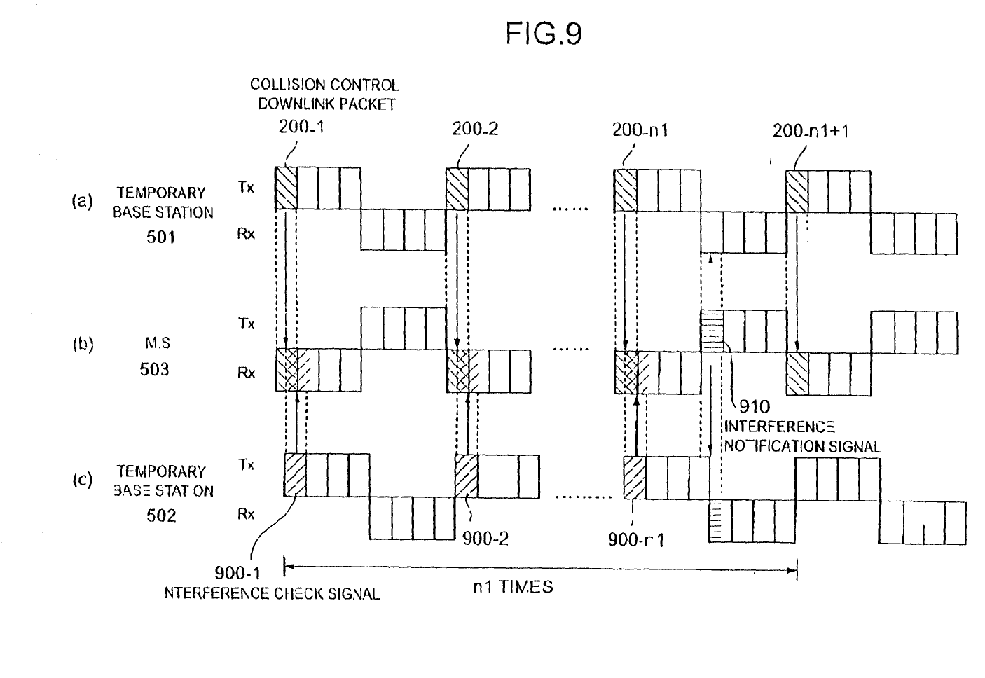

As shown in FIG. 9, when the temporary base station 502 transmits interference check signals 900_1 to 900_n1 consecutive n1 times, the above cases 1), 2) and 3) occur consecutive n1 times in total. An operation of the mobile station 503 at this time will be described with reference to FIG. 6.

In the case where the case 1) occurs at least once, the RF system 401 of the mobile station 503 receives a signal on a carrier of the channel ch1 from the temporary base station 501 and transfers it to the TDMA-TDD processor 404 (step 601) . The TDMA-TDD processor 404 extracts a signal from a redetermined slot of the received signal on the channel ch1 (step 602) and determines whether a unique word is detected from the extracted signal (step 603). Since the unique word is found in this case (YES in step 603), the TDMA-TDD processor 404 subsequently determines whether some CRC error is detected (step 604). Since no CRC error is detected in this case (NO in step 604), the TDMA-TDD processor 404_transfers the received signal to the ad hoc protocol processor 405 (step 605).

The ad hoc protocol processor 405 determines whether the received signal is interpretable (step 606). Since it is interpretable in this case (YES in step 606), the ad hoc protocol processor 405 records a packet reception result indicative of normal reception in the packet reception results memory 408 (step 607). Thereafter, the ad hoc protocol processor 405 determines whether the received signal is an interference check signal (step 608). Since it is the interference check signal in this case (YES in step 608), the interference detector 409 determines that asynchronous interference occurs and the ad hoc protocol processor 405 instructs the TDMA-TDD processor 404 to transmit an interference notification signal (step 618).

In the case where the case 2) occurs, the steps 601-603 are performed as in the above-described case 1). Since the unique word is found in this case (YES in step 603), the TDMA-TDD processor 404 subsequently determines whether some CRC error is detected (step 604). Since some CRC error is detected in this case (YES in step 604), the TDMA-TDD processor 404 informs the ad hoc protocol processor 405 that a CRC error packet has been received (step 614). This causes the ad hoc protocol processor 405 to record reception of CRC error packet in the packet reception results memory 408 (step 615). Subsequently, the control goes to the stop 610, which will be described later.

In this case where the case 3) occurs, the steps 601-603 are performed as in the above-described case 1). Since the unique word is not detected in this case (NO in step 603), the TDMA-TDD processor 404 informs the ad hoc protocol processor that the unique word has not been detected (step 612). This causes the ad hoc protocol processor 405 to record reception of a packet having no unique word detected in the packet reception results memory 408 (step 613). Subsequently, the control goes to the step 61O, which will be described hereafter.

In the step 610, the interference detector 409 determines whether C_{ERR} is equal to or greater than n3. If C_{ERR}>=n3 (YES in step 610), then the ad hoc protocol processor 405 outputs a channel switch request signal to the TDMA-TDD processor 404 and instructs to transmit the channel switch request signal (step 617). However, since C_{ERR}=n1 in this case (NO in step 610) the channel switch request signal is not transmitted. Subsequently, it is further determined whether C_{ERR} is equal to or greater than n1 (step 611). Since C_{ERR}=n1 in this case (YES in step 611), the interference detector 409 determines that asynchronous interference occurs and the ad hoc protocol processor 405 instructs the TDMA TDD processor 404 to transmit an interference notification signal 910 as shown in FIG. 9 (step 618).

As described above, in all possible combinations of the cases 1), 2) and 3), the interference notification signal is transmitted by the mobile station 503.

An operation of the temporary base station 502 when having received the interference notification signal from the mobile station 503 will be described with reference to FIG. 7. In this case, the temporary base station 502 receives the interference notification signal as either the interference notification signal itself or an error packet. If the mobile station 503 is accidentally synchronized with the temporary base station 502, then the temporary base station 502 receives the interference notification signal as it is. But, if the mobile station 503 is not synchronized with the temporary base station 502, then the temporary base station 502 receives the interference notification signal as an error packet.

Referring to FIG. 7, more specifically, in the step 708, it is determined which one of an interference notification signal and an error packet has been received. In this case, since the temporary base station 502 receives either the interference notification signal or the error packet (YES in step 708), it is determined that asynchronous interference occurs and therefore the channel in question is not available (step 711).

It should be noted that the interference notification signal is effective only for the temporary base station 502 that is a source of the interference check signal, not for the temporary base station 501 that does not transmit any interference notification signal. Accordingly, toe temporary base station 501 that does not transmit any interference notification signal performs nothing even if the interference check signal is received.

Further, the temporary base station 502 transmits an interference check packet up to n2 times (here, n2=110). The value of n2 is greater than n1 (here, n1 100), which is used as a threshold for the mobile station 503 to determine whether the interference notification signal should be transmitted so as to ensure the robustness against loss of interference check packet.

Furthermore, in the case where the temporary base station 502 has received an interference notification packet as a CRC error packet from the mobile station 503, it is possible to determine that the channel is not available when the interference notification signal has been received n5 consecutive times, where 1<n5<n3−n2, in order to taking incidental factors into account. More specifically, n5=n3−n2=120−110=10, that is, n5=1, 2, . . . , or 9. The reason why n5 has an upper limit set thereon is that, if n5>=10, then the mobile station 503 would receive error packets 120 consecutive timer and thereby transmit a channel switch signal to the temporary base station 501.

Alternatively, the interference check is repeatedly performed plural times and it may be determined based on the interference check results whether asynchronous interference occurs.

As described above, according to the first embodiment, a temporary base station transmits an interference check packet plural times before using the channel in question. If asynchronous interference occurs in an overlapping area of different ad hoc networks, then the asynchronous interference is detected by a mobile station located in the overlapping area and the temporary base station is notified, by interference notification signal, of occurrence of the asynchronous interference.

The temporary base station having transmitted the interference check packet receives the interference notification signal or error packet in response to the interference check packet and thereby can be informed of the occurrence of asynchronous interference on the channel to be used.

In this manner, the occurrence of asynchronous interference can be avoided between the temporary base stations 501 and 502 which are not synchronized, without the need of acquiring information of all mobile stations located in the area thereof or performing the complicated control of monitoring each mobile station.

2. Second Embodiment

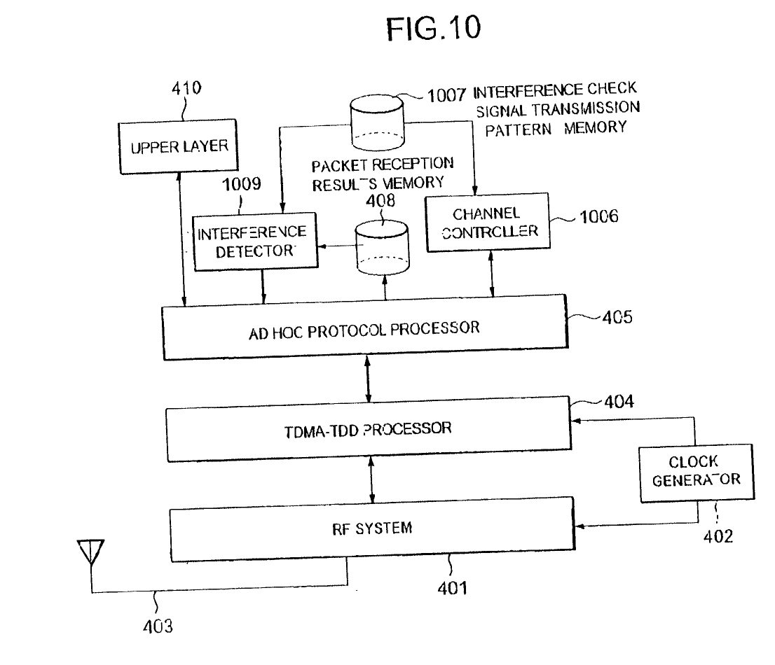

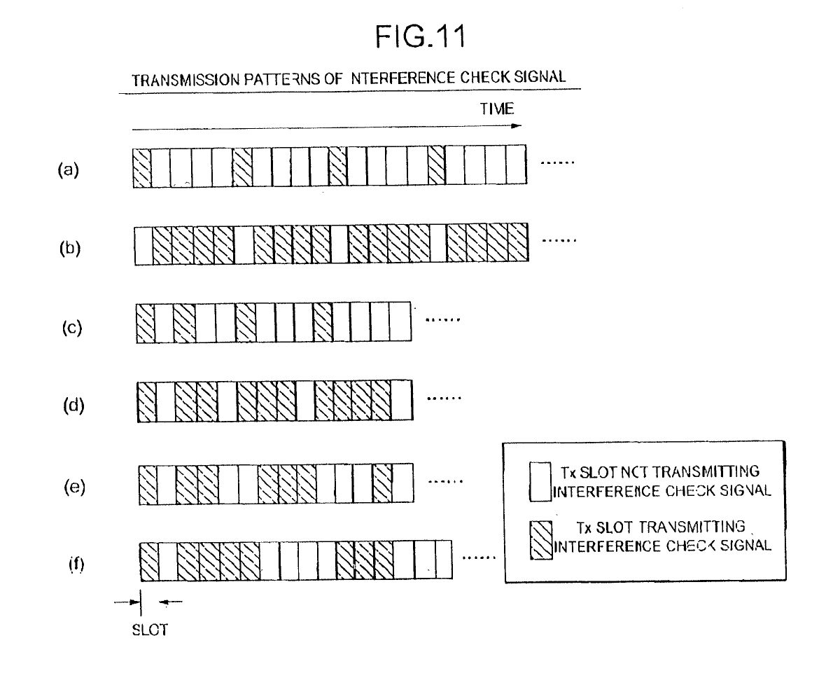

The circuit structure and operation of a terminal (mobile station or temporary base station) according to a second embodiment of the present invention will be described with reference to FIGS. 10 and 11.

In FIG. 10, blocks similar to those previously described with reference to FIG. 4 are denoted by the same reference numerals and their descriptions are omitted. In the second embodiment, an interference check signal transmission pattern memory 1007 stores a predetermined transmission pattern of an interference check signal. Several examples of the predetermined transmission pattern are shown in FIG. 11. A channel controller 1006 and an interference detector 1009 operate according to the predetermined transmission pattern stored in the interference check signal transmission pattern memory 1007.

Referring to FIG. 11, a pattern labeled (a) is to transmit an interference check signal at regular intervals (here, every five slots). A pattern labeled (b) is to transmit an interference check signal at all slots but stop transmitting at regular intervals (here, every five slots). A pattern labeled (c) is to transmit an interference check signal at intervals of a time period increasing in proportion to a lapse of time. A pattern labeled (d) is to transmit an interference check signal at all slots but stop transmitting at intervals of a time period increasing in proportion to a lapse of time. A pattern labeled (e) is to increase the number or slots transmitting an interference check signal or not transmitting in proportion to a lapse of time. A pattern labeled (f) is to alternate transmission of interference check signal for a number of consecutive slots and non-transmission for the same number of consecutive slots, the number of consecutive slots varying at random.

The transmission pattern of interference check signal is not limited to the above pattern as shown in FIG. 11. Any other pattern that is previously determined may be adopted.

The channel controller 1006 does not transmit the interference check signal at all times but according to the pattern stored in the interference check signal transmission pattern memory 1007. It is preferable that the interference check signal transmission pattern is totally different from a possible pattern of error packets occurring in the actual field.

The interference detector 1009 detects asynchronous interference when a pattern of occurrence of error packets stored in the packet reception results memory 408 matches the pattern stored in the interference check signal transmission pattern memory 1007. When the asynchronous interference has been detected, the interference notification signal is transmitted.

As described above, the temporary base station 502 transmits the interference check signal according to the pattern stored in the interference check signal transmission pattern memory 1007.

At the mobile station 503 receiving interference check signals from the temporary base station 502, the interference detector 1009 checks a pattern of packet reception results stored in the packet reception results memory 408 against the pattern stored in the interference check signal transmission pattern memory 1007. When the interference check packet has been received, it is immediately determined that asynchronous interference occurs and therefore the mobile station 503 immediately transmits an interference notification signal. However, when a packet other than the interference check packet has been received, the interference detector 1009 checks a pattern of error packets stored in the packet reception results memory 408 against the pattern stored in the interference check signal transmission pattern memory 1007. When they match, the interference notification signal is transmitted

The temporary base station 502 that desires the use of the channel ch1 transmits the interference check signal according to the pattern stored in the interference check signal transmission pattern memory 1007 and then checks whether an interference notification signal or error packet is received. If an interference notification signal or error packet is received, then the temporary base station 502 can be notified of occurrence of asynchronous interference on the channel ch1. In this case, the sequence of the asynchronous interference check may be repeatedly performed a plurality of times to ensure the reliability.

In the second embodiment, if the interference check signal transmission pattern is totally different from a possible pattern of error packets occurring in the actual field, then the number of times the interference check signal has been transmitted can he reduced.

3. Third Embodiment

The circuit structure of a terminal (mobile station or temporary base station) according to a third embodiment of the present invention is the same as that of the first embodiment as shown in FIG. 4. An operation of the third embodiment is different from that of the first embodiment in that, when the temporary base station 502 is not synchronized with the mobile station 503, the temporary base station 502 shifts the receiving timing thereof so as to be synchronized with the interference notification signal received from the mobile station 503.

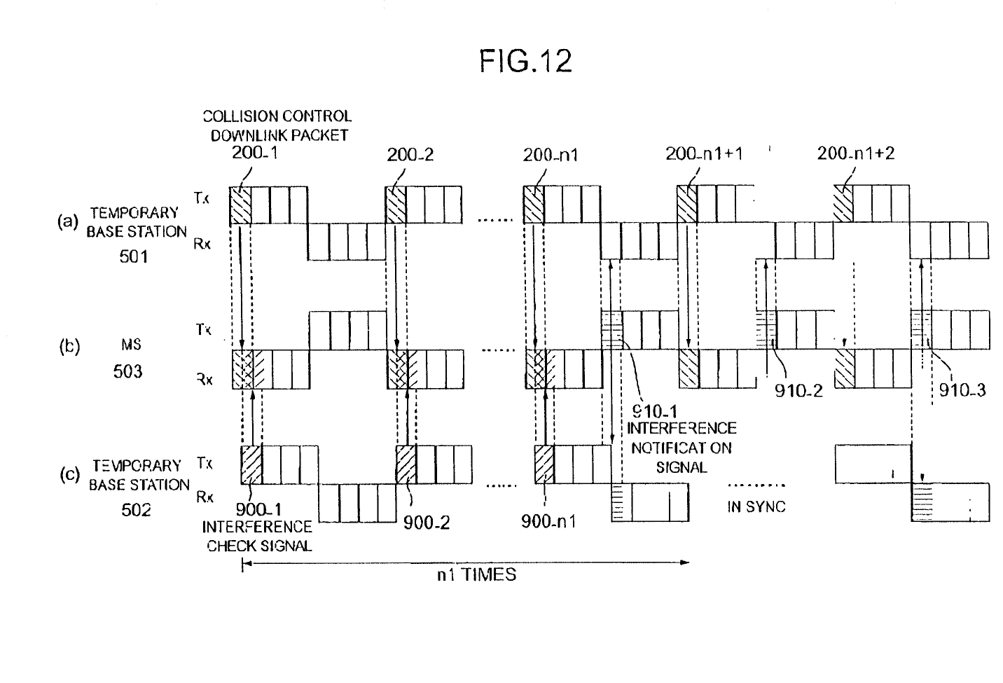

As shown in FIG. 12, it is assumed that the temporary base station 502 receives an error packet that is caused by an interference notification signal 910_1 from the mobile station 503 while transmitting interference check signals 9O0_1, 900_2, 900_3, . . . . In this case, the temporary base station 502 stops transmitting an interference check signal and then tries to be synchronized with interference notification signals 910_1, 910_2, 901_3, . . . . When the temporary base station 502 is successfully synchronized with the interference notification signals and the interference notification signal 901_3 is successfully received, the temporary base station 502 recognises that interference occurs and prohibits the user of the channel ch1. When the temporary base station 502 fails to be synchronized with the interference notification signals, the temporary base station 502 tries to repeatedly perform the sync acquisition operation several times to determine whether the channel ch1 is available.

It should be noted that it is necessary for the mobile station 503 which has detected the asynchronous interference to transmit interference notification signal a large number of times enough to stop the temporary base station 502 transmitting interference check signals 900_1, 900_2, 900_3, . . . for synchronization with the interference notification signals 910_1, 910_2, 901_3, . . . .

As described above, according to the third embodiment, the temporary base station 502 desirous of the channel ch1 is allowed to reliably receive an interference notification signal from the mobile station 503. Accordingly, asynchronous interference is effectively prevented from being misidentified due to an error packet caused by any other factor.

4. Fourth Embodiment

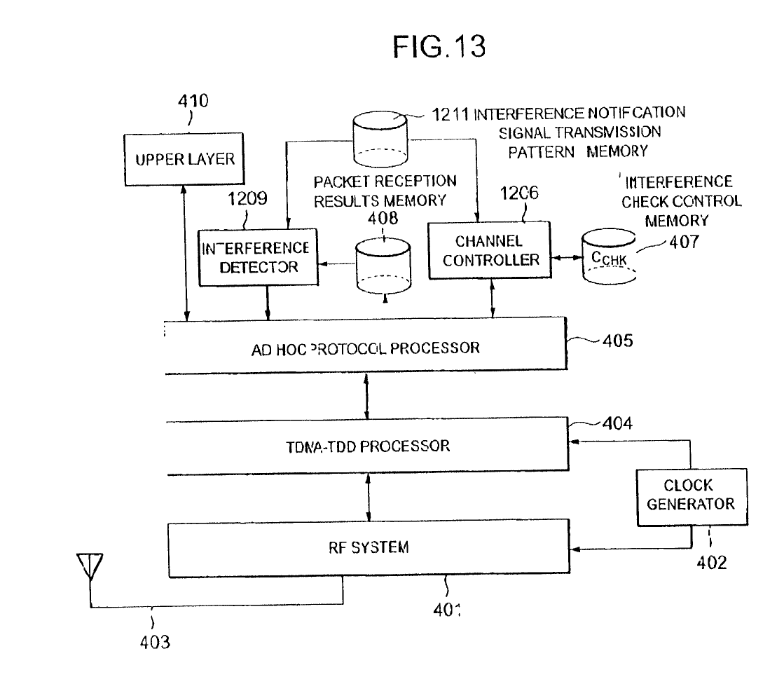

The circuit structure of a terminal (mobile station or temporary base station) according to a fourth embodiment of the present invention will be described with reference to FIG. 13.

In FIG. 13, blocks similar to those previously described with reference to FIG. 4 are denoted by the same reference numerals and their descriptions are omitted. In the fourth embodiment, an interference notification signal transmission pattern memory 1211 stores a predetermined transmission pattern of an interference notification signal. Several examples of the predetermined transmission pattern are shown in FIG. 11. A channel controller 1206 and an interference detector 1209 operate according to the predetermined transmission pattern stored in the interference notification signal transmission pattern memory 1211.

Referring to FIG. 11, a pattern labeled (a) is to transmit an interference notification signal at regular intervals (here, every five slots). A pattern labeled (b) is to transmit an interference notification signal at all slots but stop transmitting at regular intervals (here, every five slots). A pattern labeled (c) is to transmit an interference notification signal at intervals of a time period increasing in proportion to a lapse of time. A pattern labeled (d) is to transmit an interference notification signal at all slots but stop transmitting at intervals of a time period increasing in proportion to a lapse of time. A pattern labeled (e) is to increase the number of slots transmitting an interference notification signal or not transmitting in proportion to a lapse of time. A pattern labeled (f) is to alternate transmission or interference notification signal for a number of consecutive slots and non-transmission for the same number of consecutive slots, the number of consecutive slots varying at random.

The transmission pattern of interference notification signal is not limited to the above pattern as shown in FIG. 11. Any other pattern that is prepreviously determined may be adopted.

THE interference detector 1209 detects asynchronous interference when a pattern of occurrence of error packets stored in the packet reception results memory 408 matches the pattern stored in the interference notification signal transmission pattern memory 1211.

When the asynchronous interference has been detected, the channel controller 1206 controls the ad hoc protocol processor 405 so that the interference notification signal is not transmitted at all times but according to the pattern stored in the interference notification signal transmission pattern memory 1211. It is preferable that the interference notification signal transmission pattern is totally different from a possible pattern of error packets occurring in the actual field.

When the temporary base station 502 transmitting interference check signals receives interference notification signals from the mobile station 503, a pattern of error packet reception results stored in the packet reception results memory 408 is checked against the pattern stored in the interference notification signal transmission pattern memory 1211. When the pattern of error packet reception results matches the stored interference notification signal transmission pattern, the temporary ease station 502 determines that asynchronous interference occurs and therefore the channel ch1 is not available.

In this manner, the interference notification signal is transmitted according to the pattern stored in the interference notification signal transmission pattern memory 1211. Accordingly, the temporary base station 502 can be reliably notified of occurrence of asynchronous interference on the channel ch1.

5. Fifth Embodiment

The circuit structure or a terminal (mobile station or temporary base station) according to a fifth embodiment of the present invention is the same as shown in FIG. 4.

According to the fifth embodiment, when the temporary base station 502 desires the use of a slot on a carrier, the temporary base station 502 transmits an interference check signal not only through the slot on the carrier but also all slots on the carrier. Similarly, the temporary base station 502 performs receiving operation of an interference notification signal not only through the slot on the carrier but also all receiving slots on the carrier. Accordingly, the asynchronous interference avoidance method according to the fifth embodiment can effectively avoid not only asynchronous interference caused by a plurality of temporary base stations using the same slot on the carrier but also the use of the same channel by a plurality of temporary base stations. In the case where different temporary base stations use different carriers, asynchronous interference is naturally avoided.

According to the fifth embodiment, asynchronous interference can be effectively avoided by taking a small deviation of clock frequency in each temporary base station into account. More specifically, if it is checked to see that no asynchronous interference occurs, then different temporary base stations could use different slots on a carrier without any problems. However, the clock frequency of a quartz oscillator provided in each temporary base station may have a deviation. Such a clock frequency deviation causes a plurality of temporary base stations to become out of synchronization as time goes by. Accordingly, asynchronous interference that did not occur at the start becomes developed with the passage of time. That is why such synchronous interference can be completely avoided by different temporary base stations avoiding the use of two or more slots on the same carrier.

On the other hand, since different temporary base stations use different carriers, the use efficiency of a radio line is reduced. Accordingly, in the case of a sufficiently unoccupied line, the asynchronous interference avoidance method according to the fifth embodiment is adopted to distribute in-use slots over a plurality of carriers. When the amount of traffic on the line becomes greater, the asynchronous interference avoidance method according to another embodiment is adopted to allow two or more slots on a single carrier to be used after checking to see that no asynchronous interference occurs for each slot.

6. Sixth Embodiment

The circuit structure of a terminal (mobile station or temporary base station) according to a sixth embodiment of the present invention is the same as that of the first embodiment of FIG. 4.

The main point of difference between the sixth embodiment and the first embodiment is that a non modulated signal can be transmitted in place of the interference check signal. More specifically, when the interference check should be made, the ad hoc protocol processor 405 can instruct the TDMA-TDD processor 404 to transmit the non-modulated signal and then the TDMA-TDD processor 404 can instruct the RF system 401 to transit a non-modulated radio signal.

Since a non-modulated signal is transmitted by not modulating a carrier signal instead of an interference check signal, the interference check can be easily made without the need of generating a new interference check signal.

7. Seventh Embodiment

The circuit structure of a terminal (mobile station or temporary base station) according to a seventh embodiment of the present invention is the same as that of the first embodiment of FIG. 4.

The main point of difference between the seventh embodiment and the first embodiment is that the gradually increasing transmission power of an interference check signal causes a gradual widening of the interference check area around a temporary base station. More specifically, the ad hoc protocol processor 405 can instruct the TDMA-TDD processor 404 to set the transmission power of an interference check signal and then the TDMA-TDD processor 404 can instruct the RF system 401 to change its transmission power depending on the set level.

According to the seventh embodiment, the interference check signal is first transmitted with a small transmission power. When no interference notification signal is received from any mobile station, the transmission power of an interference check signal is gradually increased to the maximum transmission power while performing the interference check. If no interference notification signal is received at the maximum transmission power, then it is determined that the slot is available.

When a temporary base station transmits an interference check signal to a mobile station, there is a case where interference occurs at the mobile station and thereby the mobile station cannot make communication. According to the seventh embodiment, the gradually increasing transmission power of an interference check signal causes a gradual widening of the interference check area. Therefore, the number of mobile stations the interference occurs can be reduced to a minimum.

In the first to seventh embodiments, the mobile stations 110-112 and the temporary base station 113 constructing an ad hoc network are terminals of the mobile communication system, which have the same internal circuit structure implementing the ad hoc protocol. The present invention is not limited to such a system. The present invention can be applied to an ordinary mobile communications system composed of a plurality of cell stations and personal stations, in which a cell station is the temporary base station and a personal station is the mobile station.

1. A method for avoiding asynchronous interference in a TDMA (time division multiple access) system allowing communications among a plurality of base stations and mobile stations, comprising the steps of;
at a base station desirous of using a channel to transmit and receive signals,
a) transmitting a first predetermined signal at a slot corresponding to each of transmission and reception timings on the channel to check whether asynchronous interference occurs on the channel;
at a mobile station located in an area where the first predetermined signal can propagate,
b) determining whether asynchronous interference occurs on the channel, based on a plurality of error packet reception results on the channel;
c) when it is determined that asynchronous interference occurs, notifying the base station of occurrence or the asynchronous interference;
at the base station,
d) when the base station is successfully notified of occurrence of the asynchronous interference, determining that asynchronous interference occurs;
e) when receiving at least one error packet on the channel, determining that asynchronous interference occurs; and
f) when it is determined that asynchronous interference occurs on the channel, selecting another channel to avoid asynchronous interference.

2. A method for avoiding asynchronous interference in a TDMA (time division multiple access) system allowing communications among a plurality of base stations and mobile stations, comprising the steps of:
at a base station desirous of using a channel,
a) transmitting an interference check signal at a slot corresponding to each of transmission and reception timings on the channel to check whether asynchronous interference occurs on the channel;
at a mobile station located in an area where the interference check signal can propagate,
b) determining whether asynchronous interference occurs on the channel, based on a plurality of reception results on the channel;
c) when it is determined that asynchronous interference occurs, transmitting an interference notification signal back to the base station; and
at the base station,
d) when receiving one of the interference notification signal and an error packet as a response to the interference check signal at a receiving slot on the channel, determining that the channel is not available, and selecting another channel to avoid asynchronous interference.

3. The method according to claim 2, wherein
in the step a), the interference check signal is transmitted a predetermined number of times,
in the step b), it is determined that asynchronous interference occurs on the channel when at least a predetermined number of error packets are included in the plurality of reception results, and
in the step d), it is determined that the channel is not available when at least a predetermined number of error packets have been received on the channel.

4. The method according to claim 2, wherein
in the step a), the interference check signal is transmitted a plurality of times according to a predetermined check signal transmission pattern,
in the step b), it is determined that asynchronous interference occurs on the channel when an error packet reception pattern included in the plurality of reception results matches the predetermined check signal transmission pattern, and
in the step d), it is determined that the channel is not available when at least a predetermined number of error packets have been received on the channel.

5. The method according to claim 4, wherein the predetermined check signal transmission pattern is to transmit the interference check signal at regular intervals.

6. The method according to claim 4, wherein the predetermined check signal transmission pattern is to transmit the interference check signal at all times but stop transmitting at regular intervals.

7. The method according to claim 4, wherein the predetermined check signal transmission pattern is to transmit the interference check signal at intervals of a time period systematically varying according to a lapse of time.

8. The method according to claim 4, wherein the predetermined check signal transmission pattern is to transmit the interference check signal at all times but stop transmitting at intervals of a time period systematically varying according to a lapse of time.

9. The method according to claim 4, wherein the predetermined check signal transmission pattern is to systematically vary a number of transmitting slots of the interference check signal and a number of not transmitting slots following the transmitting slots according to a lapse of time.

10. The method according to claim 4, wherein the predetermined check signal transmission pattern is to alternate transmission of the interference check signal for a number of consecutive slots and non-transmission for the same number of consecutive slots.

11. The method according to claim 2, wherein
in the step c), the interference notification signal is transmitted a plurality of times according to a predetermined notification signal transmission pattern, and
in the step d), it is determined that the channel is not available when an error packet reception pattern matches the predetermined notification signal transmission pattern.

12. The method according to claim 11, wherein the predetermined notification signal transmission pattern is to transmit the interference notification signal at regular intervals.

13. The method according to claim 11, wherein the predetermined notification signal transmission pattern is to transmit the interference notification signal at all times but stop transmitting at regular intervals.

14. The method according to claim 11, wherein the predetermined notification signal transmission pattern is to transmit the interference notification signal at intervals of a time period systematically varying according to a lapse of time.

15. The method according to claim 11, wherein the predetermined notification signal transmission pattern is to transmit the interference notification signal at all times but stop transmitting at intervals of a time period systematically varying according to a lapse of time.

16. The method according to claim 11, wherein the predetermined notification signal transmission pattern is to systematically vary a number of transmitting slots of the interference notification signal and a number of not transmitting slots following the transmitting slots according to a lapse of time.

17. The method according to claim 11, wherein the predetermined notification signal transmission pattern is to alternate transmission of the interference notification signal for a number of consecutive slots and non-transmission for the same number of consecutive slots.

18. The method according to claim 2, wherein the step d) comprises the steps of:
when receiving an error packet as a response to the interference check signal at the reception timing, synchronizing with a signal received at the reception timing; and
determining whether the signal received at the reception timing is the interference notification signal.

19. The method according to claim 2, wherein
in the step c), the interference check signal is transmitted at all transmitting slots on a carrier including the channel,
in the step d), when receiving one of the interference notification signal and an error packet as a response to the interference check signal at at least one receiving slot on the carrier, determining that asynchronous interference occurs, and another carrier is selected.

20. The method according to claim 2, wherein
in the step a), the interference check signal is transmitted with a minimum transmission power, and
in the step d), when receiving neither the interference notification signal or the error packet, the steps a) to d) are repeatedly performed while gradually increasing transmission power of the interference check signal.

21. The method according to claim 2, wherein the interference check signal is a non-modulated signal.

22. A mobile communications system using TDMA (time division multiple access) scheme allowing communications among a plurality of base stations and mobile stations, wherein
each of the base stations comprises:
a base communication controller controlling such that, when desiring to use a channel, an interference check signal is transmitted at a slot corresponding to each of transmission and reception timings on the channel; and
a channel controller controlling such that a channel to be used is changed to another channel to avoid asynchronous interference when receiving one of the interference notification signal and an error packet as a response to the interference check signal at a receiving slot on the channel,
each of the mobile stations comprises:
a reception result memory for storing a predetermined number of last packet reception results;
an interference detector for detecting asynchronous interference on the channel based on the predetermined number of last packet reception results when receiving one of the interference notification signal and an error packet as a response to the interference check signal at a receiving slot on the channel; and
a mobile communication controller controlling such that, when asynchronous interference is detected, an interference notification signal is transmitted back to the base station.

23. The mobile communications system according to claim 22, wherein a last packet reception result indicates one of error status and normal status.

24. The mobile communications system according to claim 23, wherein the last packet reception result of a received packet indicates the error status in one of the cases where no unique word is detected, CRC error is detected, and data of the received packet is not interpretable.

25. The mobile communications system according to claim 22, wherein
the base communication controller transmits the interference check signal a predetermined number of times,
the channel controller determines that the channel is not available when at least a predetermined number of error packets have been received on the channel, and
the interference detector detects asynchronous interference on the channel when at least a predetermined number of error packets are included in the predetermined number of last packet reception results.

26. The mobile communications system according to claim 22, wherein
the base communication controller transmits the interference check signal a plurality of times according to a predetermined check signal transmission pattern,
the channel controller determines that the channel is not available when at least a predetermined number of error packets have been received on the channel, and
the interference detector detects asynchronous interference on the channel when an error packet reception pattern included in the predetermined number of last packet reception results matches the predetermined check signal transmission pattern.

27. The method according to claim 2, wherein an ad hoc network is constructed by one of mobile stations temporarily acting as a base station.

28. The mobile communications system according to claim 22, wherein an ad hoc network is constructed by one of mobile stations temporarily acting as a base station.
